(19) United States
(12) Patent Application Publication
(10) Pub. No.: US 2005/0289138 A1
(43) Pub. Date: Dec. 29, 2005

(54) Aggregate indexing of structured and unstructured marked-up content

(76) Inventors: Alex Tze-Pin Cheng, Dublin, CA (US); Jim Gan, Foster City, CA (US); Srinivas Pandrangi, Sunnyvale, CA (US)

Correspondence Address: Paul Livesay;Smyrski & Livesay, LLP, 751 Laurel Street, #438, San Carlos, CA, 94070, US

(21) Appl. No.: 10/877,396

(22) Filed: Jun. 25, 2004

(51) Int. Cl. G06F 7/00; G06F 17/00

(52) U.S. Cl. 707/5

(57) ABSTRACT

A system and method for near real-time, high performance analysis, including indexing and searching, of large amount of structured and unstructured content represented in XML format using summary information along multiple groupings. This operational data store system and method provides a new data structure representation and query technique which allows information systems software applications and end users to access key performance indicators from arbitrary content without prior knowledge relating the data-type structure or having access to the original business content. The present invention utilizes Compound Aggregate Indexes.

### FIELD OF THE INVENTION

The present invention relates generally to the field of data processing and computer system databases. More specifically, the invention relates to systems and methods for indexing and searching of large amount of structured and unstructured content in near real-time using summarized and aggregated information along multiple groupings.

In particular, but not exclusively, the present invention pertains to high performance analytical-style queries using a number of access methods and output formats of selected elements within the content and maintaining the aggregated information along multiple pre-defined sets of groupings. Summarizing data values across these selected elements are often referred to as key performance indicators (KPI) for a particular business application scenario.

### BACKGROUND OF THE INVENTION

Recent years have seen the rapid advancement and proliferation of next-generation service oriented architecture business applications based on business process management (BPM) over web services. Extensible Markup Language (XML) is a meta language for exchanging content among different platforms such as the world wide web. As such, XML is popular with business partners or customers allowing them to exchange XML data over the Internet.

Business performance management ensures a management style that plans and acts to achieve strategic and operational objectives by measuring and monitoring outcomes and drivers. Extraction, Transformation and Load (ETL) based business applications rely on data-warehouse or Online Analytical Processing applications. Corporations are affecting BPM objectives by applying KPI for a particular business application scenario. KPIs are quantifiable measurements, agreed to beforehand, that reflect the critical success factors of an organization.

Moreover, traditional Online Analytical Processing (OLAP) systems do not provide aggregated information in near real-time. These batch-oriented systems typically require long hours of data crunching and summarization processing using expensive powerful hardware and software systems. Additionally, these systems require well-structured relational data and do not adequately address web services that are inherently all XML-based content.

Additionally, simulated near real-time ETL based data-warehouse systems rely on increasing the frequency of the batch-oriented runs associated with traditional ETL based systems. This is realized by scheduling extraction scripts to run hourly or even more frequently to simulate the near real-time effect, as opposed to daily or weekly execution found in traditional ETL systems. These systems are not truly real-time and do not support web accessible BPM applications that require available up-to-the-minute information. Also, simulated near real-time ETL based systems require well-structured relational data and do not adequately address the flexible nature of any arbitrary XML content.

In addition to simulated near real-time techniques, another current approach is to use a trickle-feed method to affect a continuous update of the near real-time data warehouse as the data in the source system changes. As found with the previous two current approaches, this system requires well-structured relational data and do not adequately address the flexible nature of any arbitrary XML content.

Accordingly, there is a need for an efficient, high performance, content independent (i.e. structured and unstructured), and reliable system and method for providing near real-time business intelligence achieved in a cost-effective manner.

### SUMMARY OF THE INVENTION

The present invention is a system and method for high performance analysis of large amounts of structured and unstructured content represented in any XML format in near real-time.

The content can range from highly structured XML data (such as data from relational databases, spreadsheet, data records, or other legacy databases) to unstructured XML data (such as business documents, contracts graphic files, engineering drawings, etc.) The XML content may vary widely in structure and size, and it may contain information representing any data-types (e.g. numeric, string, date, hexadecimal, etc.).

A typical embodiment of this invention would be to support a BPM objective by analyzing a large amount of XML content based on user submitted KPI query providing highly scalable and efficient storage of summarized or aggregated information and present the results via a web based service.

The present invention has as an object to analyze any arbitrary XML content without requiring prior knowledge relating the data-type or structure by providing a summarization or aggregation of selected elements within the XML content and maintaining the summary information along multiple pre-defined set of groupings. It is a further object of the invention to be able to specify one or more elements within all XML content for which the system maintains the summary information. The summary information is maintained by the system along a set of groupings specified ahead of time, each grouping associated with an element within the XML content. Accordingly, yet a further object of the invention is to allow such summary information to be maintained incrementally on the fly and be immediately available after each business document is received and processed.

As will be evident through a further understanding of the invention, the system maintains a set of groupings and its corresponding summary information in a highly scalable and efficient fashion using a data structure called a Compound Aggregate Index (CAI). The system maintains one or more CAIs at any given time. These CAIs provide the basis for high performance analytical-style queries using a number of access methods and output formats, including the standard World Wide Web Consortium (W3C) XML Query.

### BRIEF DESCRIPTIONS OF THE DRAWINGS

FIG. 1 is a block diagram of a compound aggregate indexing system of the present invention.

FIG. 2 is a schematic illustration of a compound aggregate indexing system of the present invention.

FIG. 3 is a flowchart illustrating the use of CAI designer in defining business keys.

FIG. 4 is a flowchart illustrating the use of CAI designer in defining compound aggregate indexes.

FIG. 5 is a flowchart illustrating compound aggregate index maintenance.

FIG. 6 is a flowchart illustrating the use of CAI in XML Query processing during the query compilation phase.

FIG. 7 is a flowchart illustrating the use of CAI in XML Query processing during the query execution phase.

FIG. 8 is a flowchart illustrating the processing steps for storing a CAI.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications, and equivalents, which may be included within the spirit and scope of the invention as defined by the appended claims.

The present invention will now be described in relation to an operational data store featuring the compound aggregate indexes (CAI) architecture, CAI processing, and CAI utilization stages. Implementations of indexing and searching on both structured and unstructured content are described. Indexing and searching may be implemented for an attribute or element associated with a path within structured and unstructured content, such as, for example Extensible Markup Language (XML) data. Implementations described herein may apply to other types of structured and unstructured data such as, for example Hypertext Markup Language data, Standard Generalized Markup Language (SGML) data, Wireless Markup Language data, or other like types of structured and unstructured data, consistent with the present invention.

The CAI architecture enables near real-time results to be generated for each query request by searching summarized information that represents all information found in the submitted business content. As used herein “near real-time” refers to the timeliness of data or information, which has been delayed only by the time required for electronic communication. This implies that there are no noticeable delays. The CAI architecture uses a CAI definition mechanism to extract, aggregate, index, and store summary information based on submitted business content using specified key performance indicators. Additionally, the CAI architecture uses CAI definitions to match query request criteria to the grouping keys embedded within each definition to look up the summarized information without having to access the original business content. Thus, query results may be generated in near real-time by searching the summarized information in lieu of having to examine the elements within the business content. The term “business content” as used herein is used in its most expansive sense and applies to any arbitrary content and includes, without limitation anything from data from relational databases, spreadsheet, data records, or other legacy databases to documents, contracts, graphic files, engineering drawings, etc.

In order to define a CAI, first a specific element or attribute within the business content must be associated or mapped to given business key name. Next, one or more business keys may be selected to create a grouping key where one or more grouping keys may be compounded to form a composite key. Additionally, one or more business keys may be selected to create an aggregate key that invokes a specified aggregate function. Multiple CAI definitions may be created using this method. The term “business key” as used herein is used in its most expansive sense and applies to any arbitrary given key name and includes, without limitation anything from transaction date, region (such as city, state, and country), product type, sales, purchase orders, quantity ordered, etc.

These CAI definitions can then be processed to compute the summarized information from submitted business content. This computed summarized information represents key performance indicator values and the result is stored available for query. Query results can be formulated using the stored CAI definitions and aggregated data by attempting to match the query request criteria against the grouping keys found in the various CAI definitions. Thus, CAI are used in processing queries that require aggregated values in the same manner as used in a relational index is used in optimizing a relational SQL query. Aggregated data is recalculated each time new business content is added to the operational data store. Query requests are affected by searching the aggregated data and by transforming the query request into a lookup on a matching CAI. Searching the aggregated data in this manner allows near real-time query results to be generated and returned without having to compute the results across all of the submitted business content

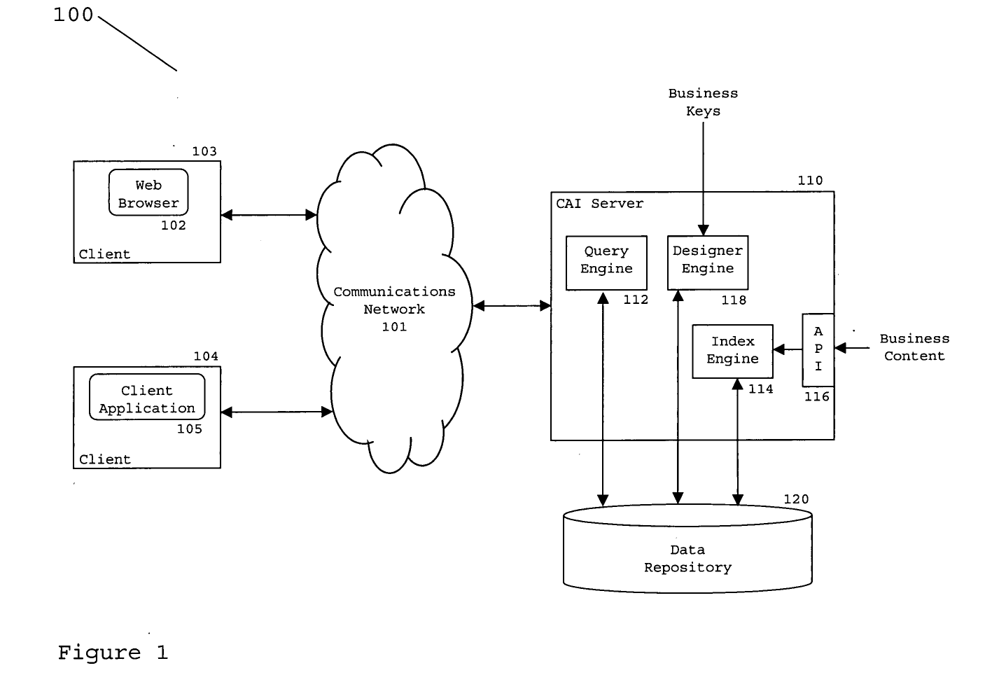

FIG. 1 is a block diagram of an exemplary system architecture 100 in which methods and systems consistent with the present invention may be implemented. This system architecture supports extracting key performance indicators from business content and querying the aggregated results based on predefined multiple groupings. System architecture 100 includes clients 103 and 105 connected to a CAI server 110 via a communications network 101. Query engine 112 is connected to a data repository 120. Index engine 114 is connected to a data repository 120. Data repository 120 stores XML data and index files consistent with the present invention. In one embodiment, data repository 120 is a database system including one or more storage devices. Data repository may store other types of information such as, for example configuration or storage use information. Communications network 101 may be the Internet, a local area network, a wide area network, wireless, or any other form of applicable communication means.

Clients 103 and 105 include user interfaces such as, for example a web browser 102 and a client application 104, respectively, to send a query request to the query engine 112 operating in CAI server 110. A query request is a search request for desired data in the data repository 120. Clients 103 and 105 can send query criteria to query engine 112 of CAI server 110 using a standard protocol such as Hypertext Markup Transfer Protocol or Structured Query Language protocol.

Query engine 112 processes a query from clients 103 or 105 by parsing the query request for execution of a search consistent with the present invention. Query engine 112 may use index files in data repository 120. Query engine 112 loads search results of records that match the query request and return the result to clients 103 or 105.

The designer engine forms index definitions based on a combination of user specified business keys and aggregate functions. Index definitions are stored as XML metadata documents in the data repository 120.

Business content is loaded into the system, perhaps via an Application Programming Interface (API) 116, or any other input/output function. Index engine 114 processes the business content in accordance with the established index definitions and computes the summarized data related to particular elements of the XML data consistent with the present invention. In one embodiment, index engine 114 stores summarized data in files available for query consistent with the present invention. System architecture 100 is suitable for use with the Java™ programming language, and other like programming languages.

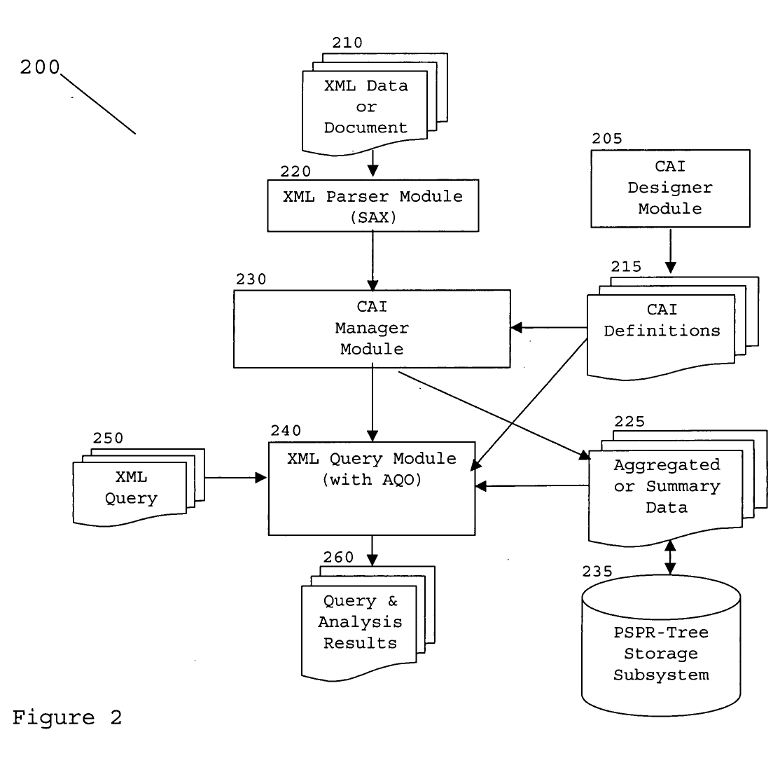

FIG. 2. is a flow diagram of a method for creating CAI definitions, indexing, storing, and searching summarized information using multiple KPI in accordance with an illustrative embodiment of the invention. The method provides indices for flexible path searching of summarized, structure independent business content. This portion of the CAI definition process of the present invention, that of mapping business keys to content elements is generally referred to as phase I; however it should be appreciated that the differentiation of phase I and phase II is for ease of explanation only and the use of such ‘phase’ nomenclature should not be considered limiting or requiring such bifurcation in actual implementation of the present invention. The first phase accepts at 205 inputs specifying a set of business keys by mapping the keys to a set of elements within an XML business document using the CAI designer module 205 via a user interface. The second phase accepts at 205 input to define a CAI by selecting one or more business keys to be the compound indexing keys as well as one or more business keys to be aggregated with certain aggregate functions (e.g. count, sum, max, min, average, top-N, bottom-N). The definition of a CAI is captured as an XML metadata document. The CAI definitions 215 are supplied to the CAI manager module 230 and the XML Query module 240, which contains the aggregate query optimizer (AQO) module.

Next, XML business content 210 is submitted and parsed by an XML Simple Application-programming interface (API) for XML (SAX) based Parser 220. The parser invokes the CAI manager module 230, which processes the CAI definitions 215 and computes the summary data 225 on-the-fly as each XML business document is being parsed. When the parser finishes parsing the XML document, the newly computed aggregated data are then stored into a persistent storage subsystem using the partially sorted packed R-Tree (PSPR-Tree) data structure 235. The summary data are then fed into the XML Query engine 240 for further processing.

In one embodiment, after all the XML business documents are processed, the user can query the summary data by submitting a W3C standard XML Query 250. The XML Query engine 240 accesses both the CAI definitions 215 and the corresponding summary data 225 to process the submitted W3C standard XML Query and return the query results 260. The details of the query processing steps are provided in the subsequent sections.

In other embodiments, a query may be provided by a business software application.

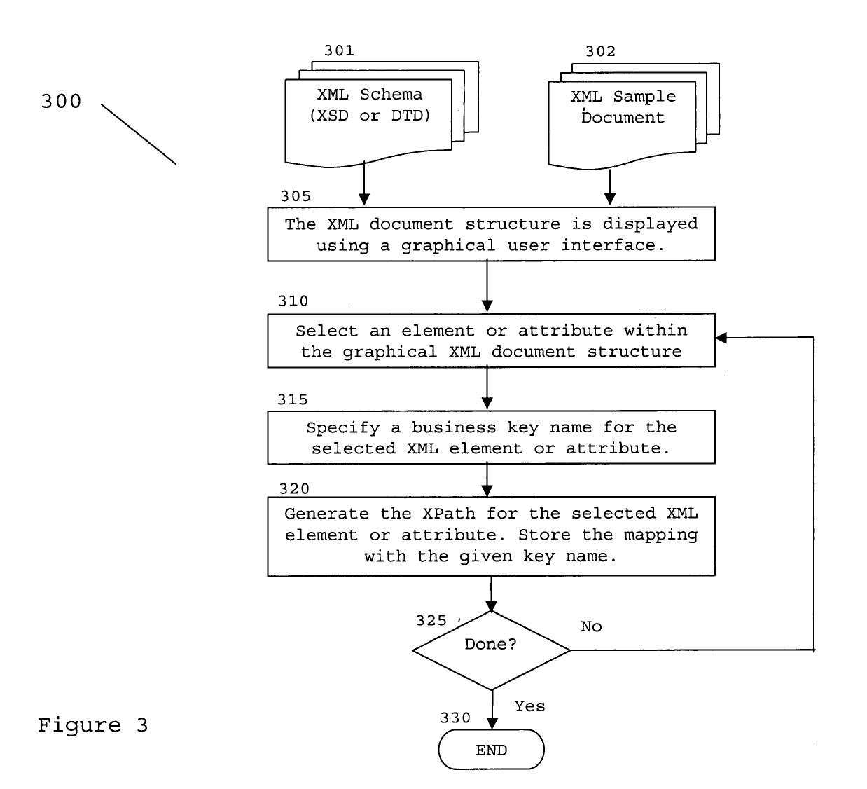

Referring now to FIG. 3, a method for specifying business keys to be associated with selected business content elements and storing this association using the CAI designer module 205 in accordance with the present invention is illustrated. The method provides a mechanism to associate business keys with selected attributes found within the business content and storing this mapping with a given key name. This resultant key can be used for subsequently specifying one of the grouping keys or aggregate keys of a CAI definition. First, a set of XML schema 301 or XML sample document 302 is submitted as input to the CAI designer module 205. The XML document structure is selected at 305 and displayed. Next, an element or attribute is selected at 310 within the XML document structure to be associated with a given business key name.

A business key name is specified at 315 within the XML document structure for the XML element or attribute selected in the previous step. Next, the CAI designer module then generates the XML Path Language (XPath) at 320, to model the XML document as a tree of nodes, for the selected XML element or attribute and stores the mapping in a persistent storage as an XML metadata document. If additional elements or attributes need to be selected within the same XML document structure, the processing is repeated at step 325. When the final element or attribute is selected and it's associated XPath generated, the mapping is stored as previously described; the CAI definition process finishes at 330.

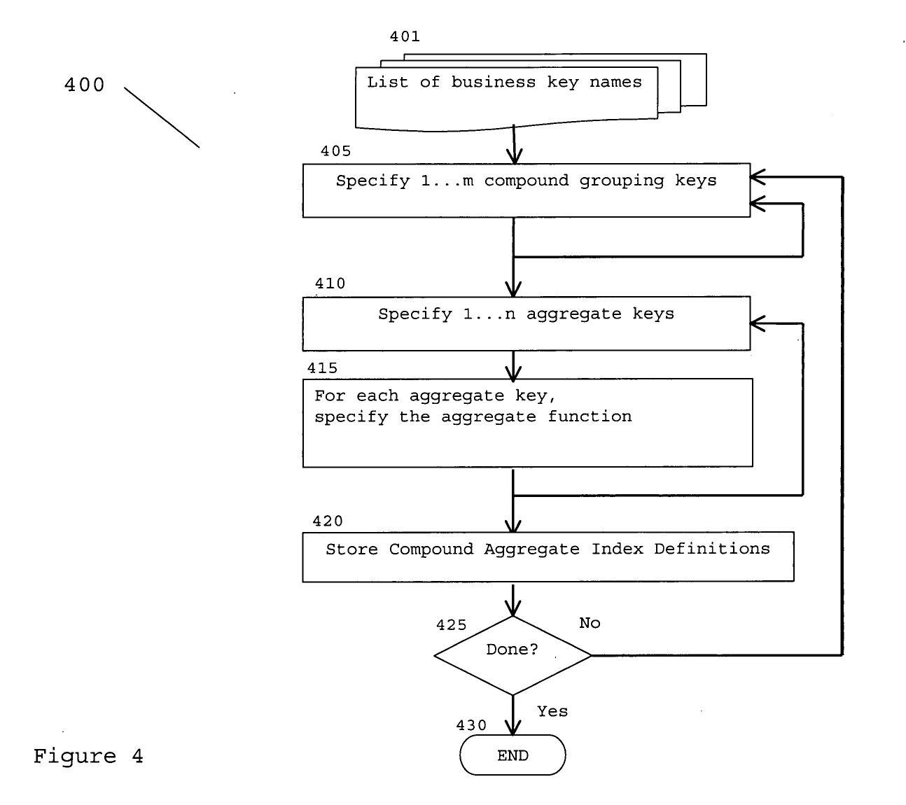

Referring to FIG. 4, a method for defining and storing compound aggregate indexes using the CAI designer module 205 in accordance with the present invention is illustrated. A CAI may be defined by a single or collection of grouping keys associated with an aggregate key in conjunction with a desired aggregate function. A grouping key may be defined as one or more business keys joined together. The CAI designer 205 displays a list of business key names at 401. First, a set of grouping keys is selected at 405 from the list of business keys for the CAI to be defined. Common grouping key examples include transaction date, geographical region (such as city, state, country) and product type. Multiple compound grouping keys can be selected from the list of business keys. The next step is to select a set of aggregate keys at 410 from the list of business keys, followed by specifying an aggregate function (e.g. count, sum, max, min, average, top-N, and bottom-N) at 415 for each aggregate key. Multiple aggregate functions can be specified for aggregate keys at 415.

Common aggregate key examples include sum of sales, count of purchase orders, and average quantity ordered. Each CAI definition 215 is saved at 420 in persistent storage as an XML metadata document.

If additional grouping keys need to be selected, the processing is repeated at step 425. When the final grouping key is selected and it's associated CAI definition is saved, the CAI definition process finishes at 430.

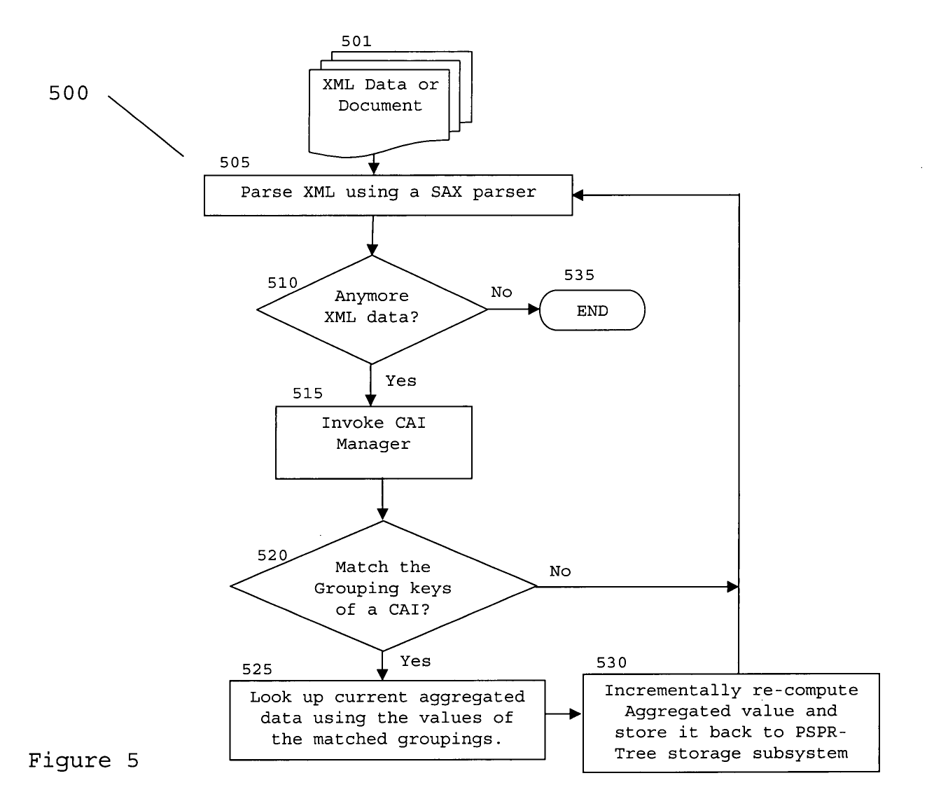

Referring to FIG. 5, a method for maintaining compound aggregate indexes using the CAI manager module 230 in accordance with the present invention is illustrated. All defined CAI are maintained and incrementally re-computed on-the-fly as new business content in the form of XML data or documents 210 is submitted to the operational data store system. The XML documents may be submitted using a in a batch-oriented or in a streaming process at 501. Each XML document is parsed at 505 using a SAX-based parser 220. Next, at step 510 a determination is made whether additional XML data needs to be processed. If XML data remains to be processed, the system invokes the CAI manager module 230. If all XML data has been processed then the systems ends at step 535. The CAI manager module 230, which is pre-loaded with all the CAI definitions 215 generated using the CAI designer module 205, is invoked at 515 to examine the XML document that is being parsed. If the set of grouping keys of a CAI matches the XML document being parsed at step 520, the data values corresponding to the grouping keys are captured, and the CAI manager module retrieves the current aggregated key values at 525 from the persistent CAI storage subsystem by performing a look-up using the grouping keys' values. Next, the CAI manager module 230 continues to scan for the aggregate keys within the input XML documents and capture all the corresponding values. The aggregated key values are incrementally re-computed in step 530 using the new set of aggregate keys' values, and the CAI manager module stores the newly aggregated values in to persistent storage subsystem 235. If the set of grouping keys of a CAI does not match the XML document being parsed at step 520, the CAI manager module returns and continues to parse the XML document at 505.

In a further embodiment of the present invention, the CAI manager module maintains an in-memory caching mechanism to improve the performance of writing to the CAI persistent storage subsystem.

The compound aggregate indexes are used in high-performance processing of an XML Query that requires aggregate values in the same manner as a relational index is being used in optimizing a relational SQL query. An XML Query input to the system undergoes two phases: XML Query compilation phase and XML Query execution phase.

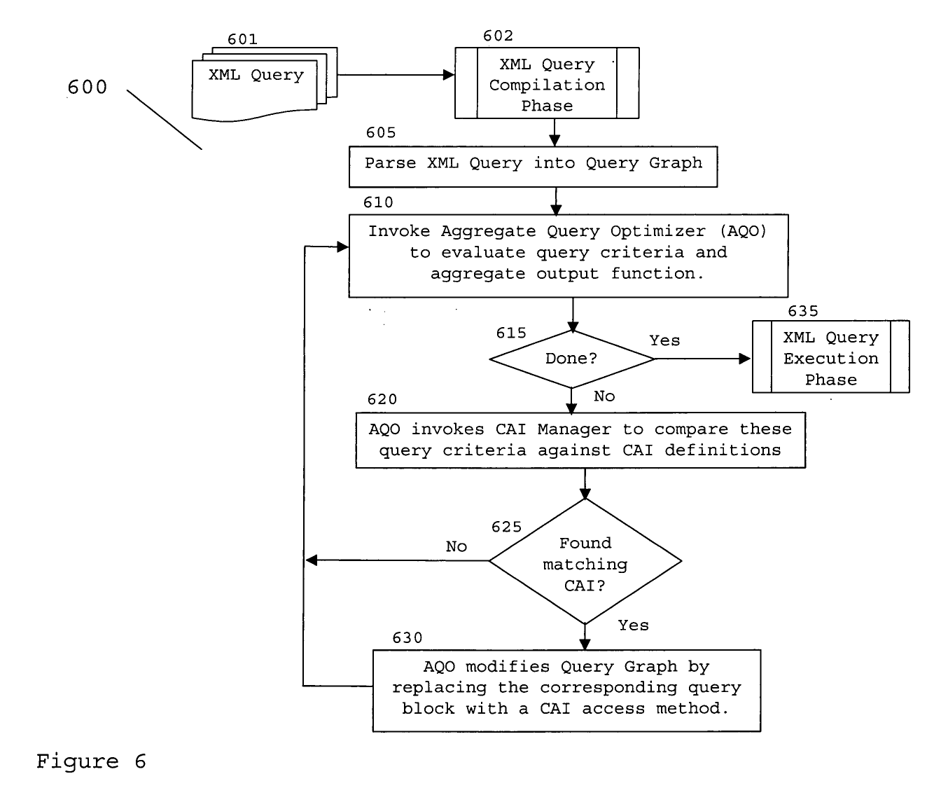

Referring to FIG. 6, a method for XML Query processing, specifically the query compilation phase at 602, using the CAI in accordance with the present invention is illustrated. This portion of the XML Query processing of the present invention, that of evaluating the query request comparing to existing CAI definitions to yield a corresponding CAI access method is generally referred to as phase I; however it should be appreciated that the differentiation of phase I and phase II is for ease of explanation only and the use of such ‘phase’ nomenclature should not be considered limiting or requiring such bifurcation in actual implementation of the present invention.

The first step of the XML Query compilation phase parses the XML Query, submitted at 601, at step 605 into a query graph representation of the query. The XML Query module 240 invokes the AQO module at 610 to examine query criteria and aggregate computation in the query graph. If the query criteria evaluation process is complete at 615, the system moves to the XML Query execution phase. If the query criteria evaluation process is not complete, the AQO module invokes the CAI manager module at 620, which is pre-loaded with all CAI definitions 215, in attempting to match the query criteria against the grouping keys of the CAI definitions 215. If a match is found at 625, the AQO has found an efficient way to look up the desired aggregate values rather than having to go through by brute-force all XML documents presented to the system so far, which the system may no long be able to access especially if they are streaming through the system. The AQO module modifies the query graph at 630 by replacing the corresponding query block with a CAI access method to produce an optimized query graph that will be invoked during the query execution phase 635. The AQO module continues to be invoked until the query evaluation process is completed. If no matching CAI is found at step 625, processing loops back to invoke the AQO module at step 610.

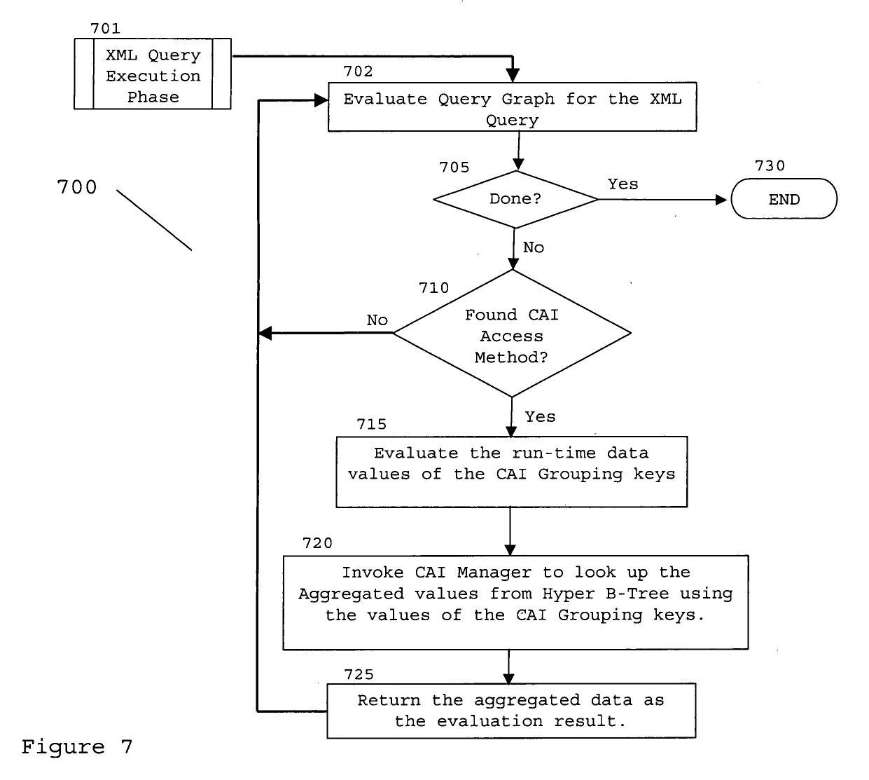

Referring to FIG. 7, a method for XML Query processing, specifically the query execution phase 635 at 701, using the CAI in accordance with the present invention is illustrated. The first step of the XML Query execution phase, the XML Query module 240 evaluates the compiled, optimized query graph at step 702. If a CAI access method is found at 710, the XML Query module gathers the run-time data values 715 of the grouping keys and invokes the CAI manager module 230 to access the aggregated values directly from the CAI data repository at 720. The XML Query module then returns the aggregated values as part of the query results at step 725. The query graph continues to be evaluated for the XML Query at step 702 until the query graph evaluation process is completed. If the XML Query module 240 has completed the evaluation of the optimized query graph at step 705 the processing finishes at 730. If a CAI access method is not found at 710, the XML Query module continues to evaluate the query graph at 702.

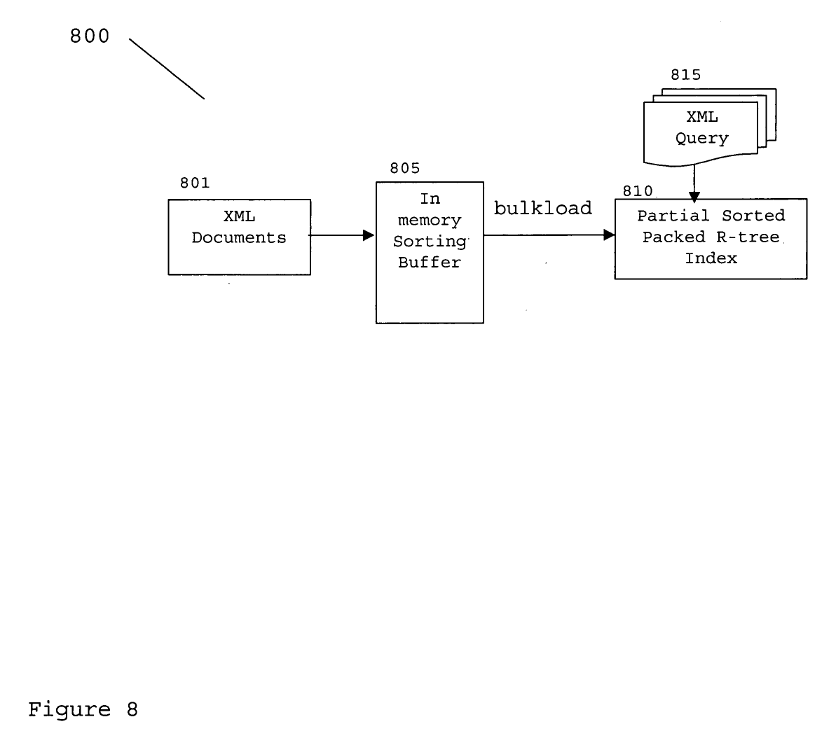

Referring to FIG. 8, a method for storing each CAI within a partial sorted, packed R-tree persistent storage subsystem in accordance with the present invention is illustrated. Each index at 801 is submitted to an in-memory sorting buffer at 805 specific for each index to sort keys (k1, k2, . . . kn) by the first dimension k1, then the second dimension k2, and so on through kn. When the sorting buffer is full, these indexes are bulk load, by insert them consecutively, into PSPR-tree to fill its leaf nodes. Each compound index is stored as a PSPR-tree at 810. The stored indexes are now available for searching at step 815.

In this way PSPR-tree is packed so that query is more efficient. After the bulk load, the sorting buffer is emptied and ready for next use. The partial sorted, packed R-tree as the compound aggregate index makes the R-tree well balanced and the leaf data page full. The data page contains partial sorted data because data are sorted in in-memory buffer and bulk loaded into R-tree.

The foregoing descriptions of specific embodiments of the present invention have been presented for the purposes of illustration and description. They are not intended to be exhaustive or to limit the invention to the precise forms disclosed, and should be understood that many modifications and variations are possible in light of the above teaching. The embodiments were chosen and described in order to best explain the principle of the invention and its practical application, to thereby enable others skilled in the art to best utilize the invention and various embodiments with various modifications as are suited to the particular use contemplated. The present invention has been described in a general operational data store environment. However, the present invention has applications to other databases such as network, hierarchical, relational, or object oriented databases. Therefore, it is intended that the scope of the invention be defined by the claims appended hereto and their equivalents.

1. A method for creating an indexed data structure for storing and querying indexed data of a plurality of XML documents, said method comprising:
a. Relating an element contained in an XML document to a business key, wherein said business key is correlated to a key performance indicator;
b. Generating an XPath for each said element, wherein said XPath models an XML document as a tree of nodes;
c. Storing the XPath of each said element with the business key to which said element relates;
d. Defining one or more grouping keys, each said grouping key comprised of at least one business key;
e. Defining one or more aggregate keys, each said aggregate keys specifying an aggregate function; and
f. Generating the desired indexed data structure as a compound aggregate index comprised of one or more definitions, wherein each said definition is an association of one or more grouping keys with at least one aggregate key.

2. A method as in claim 1 further comprising: storing said compound aggregate index in a data repository comprising a persistent storage mechanism.

3. A method as in claim 1 further comprising: parsing the business content by applying a definition of the compound aggregate index to extract one or more elements.

4. A method as in claim 3 further comprising: generating a compound aggregate index access method, wherein said access method matches the grouping keys within said compound aggregate index definitions.

5. A method as in claim 4 further comprising:
a. Retrieving and processing aggregated information using the compound aggregate index access method;
b. Re-processing aggregated information by grouping and applying aggregate functions to extracted elements;
c. Storing said aggregated information in all compound aggregate indexes that are applicable.

6. A method for indexing semi-structured data, said method comprising:
a. Relating an element of semi-structured data to a business key;
b. Modeling the semi-structured data into a hierarchal data structure comprised of nodes, wherein each element is mapped to the business key to which it relates;
c. Defining one or more grouping keys, each said grouping key comprised of at least one business key;
d. Defining one or more aggregate keys, each said aggregate keys specifying an aggregate function; and
e. Generating a compound aggregate index comprised of one or more definitions, wherein each said definition is an association of one or more grouping keys with at least one aggregate key.

7. A method as in claim 6 further comprising: storing said compound aggregate index in a data repository that is a persistent storage mechanism.

8. A method as in claim 6 further comprising: parsing the semi-structured data by applying a definition of the compound aggregate index to extract a plurality of elements.

9. A method as in claim 8 further comprising: generating an access method correlating a definition, wherein said access method matches the grouping keys within the correlated definition.

10. A method as in claim 9 further comprising: retrieving and processing aggregated information using the compound aggregate index access method, and re-processing aggregated information by grouping and applying aggregate functions to extracted elements.

11. A method as in claim 10 wherein said aggregated information is stored in each definition of the compound aggregate indexes having an associated business key or grouping key.

12. A system for indexing data to support near real-time query of such data, comprising:
a. A designer engine configured to generate one or more compound aggregate index definitions, each said definition comprising a data structure for storing aggregated information that resulted from extracting elements from business content;
b. An index engine configured to extract elements from business content based on said compound aggregate index definitions, said indexing engine further configured to aggregate information resulting from said elements; and
c. A data repository configured for storage and retrieval of the compound aggregate index definitions and aggregated information.

13. The system of claim 12, further comprising a query engine configured to evaluate the query criteria and search said aggregated information based on said compound aggregate index access method to retrieve aggregated information.

14. The system of claim 12, wherein the data repository comprises a persistent index storage mechanism.

15. The system of claim 12, further comprising an in-memory caching mechanism for writing compound aggregate indexes to the data repository.

16. The system of claim 12, further comprising an application programming interface for receiving business content submitted electronically.

17. The system of claim 12, further comprising a browser-based client interface for querying the stored aggregated information.

18. The system of claim 12, further comprising a software application based interface for querying the stored aggregated information.

19. The system of claim 12, further comprising a communications network connecting browser based clients and software application based clients to connect to the compound aggregated index server for querying the stored aggregated information.

20. A method of defining a data structure to support real time query of such content, said method comprising of the steps of:
a. Mapping a business key to one or more elements within each content structure and applying a key name to said mapping;
b. Generating a grouping key by combining one or more business keys;
c. Generating an aggregate key by combining one or more business keys;
d. Mapping an aggregate function to each aggregate key; and
e. Storing the result as a compound aggregate index definition in a metadata document.

21. The method of claim 20 further comprising:
a. Receiving a query request;
b. Parsing the query request into a query graph;
c. Evaluating the query criteria and aggregate output function;
d. Comparing the query criteria against compound aggregate index definitions by matching query requests to grouping keys found within one or more compound aggregate index definitions;
e. Replacing the query criteria with a compound aggregate index definitions access method and updating the query graph;
f. Evaluating the query graph;
g. Searching for each compound aggregate index access method;
h. Searching aggregated information by using the values of the matched CAI grouping keys; and
i. Returning the aggregated information as the evaluation result.
